(19) United States
(12) Patent Application Publication
(10) Pub. No.: US 2025/0045082 A1
(43) Pub. Date: Feb. 6, 2025

(54) DETERMINING A GENERALIZED ROUTINE BASED ON IDENTIFIED USER ACTIONS

(71) Applicant: GOOGLE LLC, Mountain View, CA (US)

(72) Inventors: Cliff Kuang, San Francisco, CA (US); Adam Coimbra, Los Altos, CA (US); Bogdan Prisacari, Adliswil (CH); Felix Weissenberger, Zurich (CH); Eric Stavarache, Zurich (CH); Mugurel-Ionut Andreica, Adliswil (CH); Jonathan Splitlog, Mountain View, CA (US); Caleb Misclevitz, Portland, OR (US)

(21) Appl. No.: 18/793,675

(22) Filed: Aug. 2, 2024

Related U.S. Application Data
(60) Provisional application No. 63/530,911, filed on Aug. 4, 2023.

(51) Int. Cl. G06F 9/451; G06F 3/0484; G06V 40/20

(52) U.S. Cl. CPC G06F 9/453; G06F 3/0484; G06V 40/20

(57) ABSTRACT

Implementations relate to determining a general routine when an automated assistant is not configured to fulfill a user request. When the user submits a request to an automated assistant to perform a routine and the automated assistant is not configured to fulfill the request, the user demonstrates the actions that are included in the routine. The automated assistant generates a routine based on the actions of the user and stores the routine with the request that was initially submitted by the user. In some implementations, a general routine can include one or more parameters and the user provides a value for the parameters with the request. General routines can additionally be generated based on previous routines performed by the user and/or other users.

### BACKGROUND

A significant number of tasks that are performed by users on mobile devices are repetitive and may be performed multiple times a day and/or may be performed by multiple users in the same or a similar manner. In some instances, the series of steps that comprise a task may be difficult for a user to remember, may be time-consuming for the user to perform as needed, and/or may otherwise hinder a user from utilizing a mobile device to its fullest benefit.

For some tasks, a user may not know the full capabilities of a mobile device and may therefore perform some tasks less optimally than how the task(s) could otherwise be performed. Further, some tasks may require a user to access multiple applications, perform multiple steps in a particular order, and/or provide repetitive input in order to complete a task. Thus, user input can be prone to errors that can inhibit performance of a desired task.

However, for some tasks, the user may not be aware that an automated assistant is unable to automatically perform an action. In some instances, a request to an automated assistant may be for a task that has not been previously requested by the user and/or may be tailored to the specific needs of the user. Because an automated assistant is constrained to a limited number of tasks, any requests for tasks that have not been developed may result in a failure to fulfill the request. Further, because new applications are continuously being released, an automated assistant may not yet be configured to interact with one or more newer applications.

### SUMMARY

Techniques are described herein for generating a general macro that has not been previously generated and which can be executed by an automated assistant to automatically perform a routine. The actions included in the general macro can be determined based on identifying one or more actions manually performed by the user while performing the routine. Once the macro has been generated that mimics the user actions, one or more actions can be identified as parameters that may vary depending on the request of the user. Further, once the general macro has been generated and a request pattern has been determined, the macro can be reused for other requests to perform similar tasks.

As an example, a user may utter the request “Play Book 1 on Application A” to an automated assistant. In some instances, the automated assistant may not be configured to interact with “Application A” and/or the automated assistant may not recognize the request. In response, the automated assistant may provide a failure notification to the user that indicates that the request cannot be fulfilled, such as “I don't know how to do that yet.” However, implementations described herein can instead provide a notification that indicates that the automated assistant can be configured to perform the routine if the user demonstrates performing the routine. For example, the automated assistant can instead provide a notification that indicates “I can't do that yet. Would you like to teach me how?” If the user responds affirmatively, the automated assistant can initiate a training component that records the actions of the user and determines how to perform the same actions automatically.

In some implementations, the automated assistant can process captured screen recordings (or snapshots) of the user performing the actions via an interface of a mobile device. For example, a routine can include the user selecting an icon for an audio book application, typing the name of a book into a text box, and selecting an “OK” button. Screenshots of the user performing the actions can be captured and one or more components can analyze the screenshots to determine what actions were performed. In some implementations, one or more machine learning models can be utilized, such as a machine learning model that is trained to receive, as input, one or more screenshots and provide, as output, one or more probabilities, each associated with a particular action being performed by the user. In some implementations, one or more other image analysis techniques can be utilized to determine, from the screenshots and/or recordings, what action(s) were performed by the user while the images were captured.

In some implementations, the automated assistant and/or operating system executing on the mobile device can utilize one or more APIs to determine the actions of the user. For example, the automated assistant can receive, in response to an API call, screen hierarchy information. Screen hierarchy information can indicate, for example, what is currently being displayed on the screen, location information that indicates where the user interacted with the interface screen, what data was entered by the user during a particular action, and/or additional low-level details of what was caused by the user actions.

Once the automated assistant (and/or one or more other components) determines the actions of the user, the actions can be combined to generate a routine template for the routine that was requested by the user. For example, the user may perform the actions, as described with regard to the previous example, and a routine can be generated that includes those actions and/or actions that automatically perform the routine. For example, the user may select a button on an interface and the automated assistant can utilize an API call to the application that results in the same action. The routine can be stored with the request that was submitted by the user such that, in future interactions, when the user submits the same request, the automated assistant will not provide a failure notification but can instead perform the routine.

In some implementations, a routine template may be generalizable such that the similar actions may be performed automatically for different input from the user. For example, a routine template can be generated for the request “Play Book 1 on Application A,” and the automated assistant can determine that “Book 1” is a parameter that may vary from request to request. Instead of generating a routine template for “Play Book 1 on Application A,” the automated assistant can determine a template of “Play <book title> on Application A.” Thus, if the user subsequently submits a request of “Play Book 2 on Application A,” the automated assistant may not provide a failure notification but can instead perform the same actions as were automatically performed when the user submitted the request “Play Book 1 on Application A” with the exception of using “Book 2” as a parameter in lieu of using “Book 1.”

The automated assistant can determine which actions include parameterizable input from the user that may change from request to request. In some implementations, the automated assistant can determine that, when performing the actions, the user selected an option from a drop-down menu and/or entered text that corresponds to one or more terms in the submitted request. For example, an action of the user may include selecting an icon and/or selecting, from a drop-down menu, a selection of “Book 1” for the actions performed by the user when requested to demonstrate performing “Play Book 1 on Application A.” Alternatively, the user may be presented with a text box and, as part of an action, enter “Book 1.” Based on one of these actions, the automated assistant can determine a routine template of “Play <book title> on Application 1.”

In some implementations, one or more previous requests by the user (or a plurality of users) can be utilized to determine whether one or more terms in a request are parameterizable. For example, a user may submit a request of “Play Book 1 on Application A,” a request of “Play Book 2 on Application A,” and a request of “Play Book 3 on Application A.” The automated assistant can determine, based on the three requests, that the only difference is in the name of the book. By identifying that the book titles are of the same entity type, the automated assistant can determine that a generalized routine template for a routine can be determined, such as “Play <book title> on Application A” which can be associated with the actions that were performed by the user.

As previously mentioned, the requests of multiple users can be utilized to determine a template and to associate the template with a plurality of actions. Similarly, once a template is associated with actions, the routine template (and corresponding actions) can be provided to one or more additional users. For example, User 1 may have performed the actions that were identified by the automated assistant, and the resulting routine/actions can be provided to a second user and a third user. Thus, by only generating a routine once and then providing the routine to others, computing resources can be conserved because each of the other users do not need to go through the steps to generate the template, the template need not be generated multiple times, and other users (and the first user) can request a routine automatically without receiving a failure notification and then performing the actions manually for each instance.

The above description is provided as an overview of some implementations of the present disclosure. Further description of those implementations, and other implementations, are described in more detail below.

### BRIEF DESCRIPTION OF THE DRAWINGS

FIG. 1 is a block diagram of an example environment in which implementations disclosed herein can be implemented.

FIG. 2A, FIG. 2B, and FIG. 2C depict example interfaces illustrated via a user interface of a user device.

FIG. 3A and FIG. 3B illustrate failure notifications provided by an automated assistant.

FIG. 4A, FIG. 4B, and FIG. 4C illustrate user actions that are included in a routine.

FIG. 5A depicts a flowchart illustrating an example method according to various implementations disclosed herein.

FIG. 5B depicts a flowchart illustrating another example method according to various implementations disclosed herein.

FIG. 6 illustrates an example architecture of a computing device.

### DETAILED DESCRIPTION

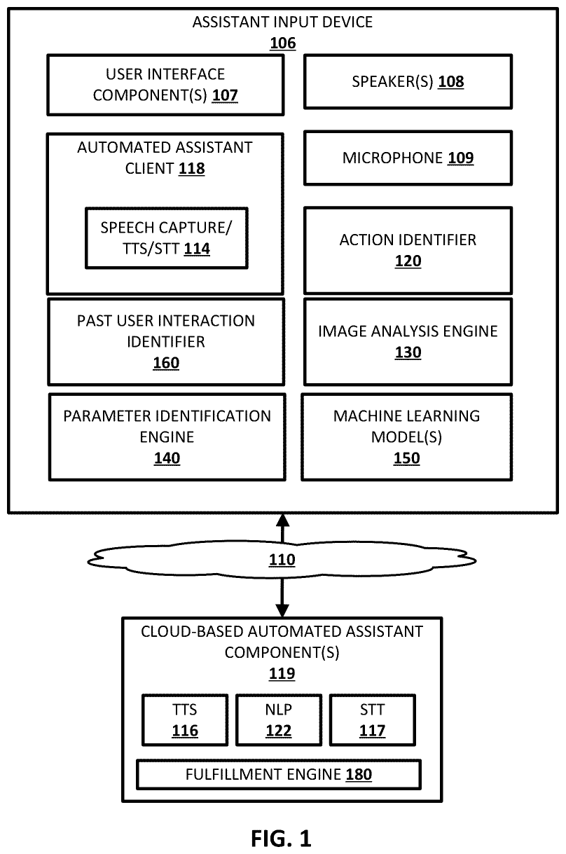

Turning now to FIG. 1, an example environment in which techniques disclosed herein may be implemented is illustrated. The example environment includes assistant input device 106 and one or more cloud-based automated assistant components 119. Assistant input device 106 can execute an instance of automated assistant client 118. However, in some implementations one or more of the assistant input devices can optionally lack an instance of the respective automated assistant client 118, and still include engine(s) and hardware components for receiving and processing user input directed to an automated assistant (e.g., microphone(s) 109, speaker(s) 108, speech recognition engine(s), natural language processing engine(s), speech synthesis engine(s), and so on). An instance of the automated assistant client 118 can be an application that is separate from an operating system of the assistant input devices 106 (e.g., installed “on top” of the operating system)—or can alternatively be implemented directly by the operating system of the assistant input device 106. As described further below, the automated assistant client 118 can optionally interact with one or more cloud-based automated assistant components 119 in responding to various requests provided by respective user interface components 107. Further, and as also described below, other engine(s) of the assistant input device 106 can optionally interact with one or more of the cloud-based automated assistant components 119.

One or more the cloud-based automated assistant components 119 can be implemented on one or more computing systems (e.g., server(s) collectively referred to as a “cloud” or a “remote” computing system) that are communicatively coupled to assistant input device 106 via one or more local area networks (“LANs,” including Wi-Fi LANs, Bluetooth networks, near-field communication networks, mesh networks, etc.), wide area networks (“WANs,”, including the Internet, etc.), and/or other networks. The communicative coupling of the cloud-based automated assistant components 119 with the assistant input device 106 is indicated generally by 110 of FIG. 1. Also, in some implementations, the assistant input device 106 may be communicatively coupled with one or more other assistant input devices via one or more networks (e.g., LANs and/or WANs).

An instance of an automated assistant client 118, by way of its interactions with one or more of the cloud-based automated assistant components 119, may form what appears to be, from a user's perspective, a logical instance of an automated assistant with which the user may engage in a human-to-computer dialog. For example, a first automated assistant can be encompassed by a first automated assistant client 118 of a first assistant input device 106 and one or more cloud-based automated assistant components 119. A second automated assistant can be encompassed by a second automated assistant client 118 of a second assistant input device 106 and one or more cloud-based automated assistant components 119. The first automated assistant and the second automated assistant may also be referred to herein simply as “the automated assistant”. It thus should be understood that each user that engages with an automated assistant client 118 executing on one or more of the assistant input devices 106 may, in effect, engage with his or her own logical instance of an automated assistant (or a logical instance of automated assistant that is shared amongst a household or other group of users and/or shared amongst multiple automated assistant clients 118). Although only a single assistant input device 106 is illustrated in FIG. 1, it is understood that cloud-based automated assistant component(s) 119 can additionally serve many additional groups of assistant input devices. Moreover, although various engines of the cloud-based automated assistant components 119 are described herein as being implemented separate from the automated assistant clients 118 (e.g., at server(s)), it should be understood that it is for the sake of example and is not meant to be limiting. For instance, one or more (e.g., all) of the engines described with respect to the cloud-based automated assistant components 119 can be implemented locally by one or more of the assistant input devices.

The assistant input device 106 may include, for example, one or more of: a desktop computing device, a laptop computing device, a tablet computing device, a mobile phone computing device, a computing device of a vehicle of the user (e.g., an in-vehicle communications system, an in-vehicle entertainment system, an in-vehicle navigation system), an interactive standalone speaker (e.g., with or without a display), a smart appliance such as a smart television or smart washer/dryer, a wearable apparatus of the user that includes a computing device (e.g., a watch of the user having a computing device, glasses of the user having a computing device, a virtual or augmented reality computing device), and/or any IoT device capable of receiving user input directed to the automated assistant. Additional and/or alternative assistant input devices may be provided. In some implementations, the assistant input device 106 can be associated with other assistant input devices in various ways in order to facilitate performance of techniques described herein. For example, in some implementations, the assistant input device 106 may be associated with another by virtue of being communicatively coupled via one or more networks (e.g., via the network(s) 110 of FIG. 1). This may be the case, for instance, where the plurality of assistant input devices are deployed across a particular area or environment, such as a home, a building, and so forth. Additionally, or alternatively, in some implementations, assistant input device 106 may be associated with one or more other assistant input devices by virtue of them being members of a coordinated ecosystem that are at least selectively accessible by one or more users (e.g., an individual, a family, employees of an organization, other predefined groups, etc.). In some of those implementations, the ecosystem of the plurality of assistant input devices can be manually and/or automatically associated with each other in a device topology representation of the ecosystem.

Additionally, or alternatively, in some implementations, the assistant input device 106 may perform speaker recognition to recognize a user from their voice. For example, some instances of the automated assistant may be configured to match a voice to a user's profile, e.g., for purposes of providing/restricting access to various resources. Various techniques for user identification and/or authorization for automated assistants have been utilized. For example, in identifying a user, some automated assistants utilize text-dependent techniques (TD) that is constrained to invocation phrase(s) for the assistant (e.g., “OK Assistant” and/or “Hey Assistant”). With such techniques, an enrollment procedure is performed in which the user is explicitly prompted to provide one or more instances of a spoken utterance of the invocation phrase(s) to which the TD features are constrained. Speaker features (e.g., a speaker embedding) for a user can then be generated through processing of the instances of audio data, where each of the instances captures a respective one of the spoken utterances. For example, the speaker features can be generated by processing each of the instances of audio data using a TD machine learning model to generate a corresponding speaker embedding for each of the utterances. The speaker features can then be generated as a function of the speaker embeddings, and stored (e.g., on device) for use in TD techniques. For example, the speaker features can be a cumulative speaker embedding that is a function of (e.g., an average of) the speaker embeddings. Text-independent (TI) techniques have also been proposed for utilization in addition to or instead of TD techniques. TI features are not constrained to a subset of phrase(s) as is in TD. Like TD, TI can also utilize speaker features for a user and can generate those based on user utterances obtained through an enrollment procedure and/or other spoken interactions, although many more instances of user utterances may be required for generating useful TI speaker features.

After the speaker features are generated, the speaker features can be used in identifying the user that spoke a spoken utterance. For example, when another spoken utterance is spoken by the user, audio data that captures the spoken utterance can be processed to generate utterance features, those utterance features compared to the speaker features, and, based on the comparison, a profile can be identified that is associated with the speaker features. As one particular example, the audio data can be processed, using the speaker recognition model, to generate an utterance embedding, and that utterance embedding can be compared with the previously generated speaker embedding for the user in identifying a profile of the user. For instance, if a distance metric between the generated utterance embedding and the speaker embedding for the user satisfies a threshold, the user can be identified as the user that spoke the spoken utterance.

Each of the assistant input devices 106 further includes respective user interface component(s) 107, which can each include one or more user interface input devices (e.g., microphone, touchscreen, keyboard, and/or other input devices) and/or one or more user interface output devices (e.g., display, speaker, projector, and/or other output devices). As one example, user interface components 107 of assistant input device 106 can include only speaker(s) 108 and microphone(s) 109, whereas user interface components 107 of another assistant input device 106 can include speaker(s) 108, a touchscreen, and microphone(s) 109.

Each of the assistant input devices 106 and/or any other computing device(s) operating one or more of the cloud-based automated assistant components 119 may include one or more memories for storage of data and software applications, one or more processors for accessing data and executing applications, and other components that facilitate communication over a network. The operations performed by one or more of the assistant input devices 106 and/or by the automated assistant may be distributed across multiple computer systems. The automated assistant may be implemented as, for example, computer programs running on one or more computers in one or more locations that are coupled to each other through a network (e.g., the network(s) 110 of FIG. 1).

As noted above, in various implementations, the assistant input device 106 may operate a respective automated assistant client 118. In various embodiments, each automated assistant client 118 may include a respective speech capture/text-to-speech (TTS)/speech-to-text (STT) module 114 (also referred to herein simply as “speech capture/TTS/STT module 114”). In other implementations, one or more aspects of the respective speech capture/TTS/STT module 114 may be implemented separately from the respective automated assistant client 118 (e.g., by one or more of the cloud-based automated assistant components 119).

Each respective speech capture/TTS/STT module 114 may be configured to perform one or more functions including, for example: capture a user's speech (speech capture, e.g., via respective microphone(s) 109); convert that captured audio to text and/or to other representations or embeddings (STT) using speech recognition model(s) stored in a database; and/or convert text to speech (TTS) using speech synthesis model(s) stored in a database. Instance(s) of these model(s) may be stored locally at each of the respective assistant input devices 106 and/or accessible by the assistant input devices (e.g., over the network(s) 110 of FIG. 1). In some implementations, because one or more of the assistant input devices 106 may be relatively constrained in terms of computing resources (e.g., processor cycles, memory, battery, etc.), the respective speech capture/TTS/STT module 114 that is local to each of the assistant input devices 106 may be configured to convert a finite number of different spoken phrases to text (or to other forms, such as lower dimensionality embeddings) using the speech recognition model(s). Other speech input may be sent to one or more of the cloud-based automated assistant components 119, which may include a cloud-based TTS module 116 and/or a cloud-based STT module 117.

Cloud-based STT module 117 may be configured to leverage the virtually limitless resources of the cloud to convert audio data captured by speech capture/TTS/STT module 114 into text (which may then be provided to natural language processing (NLP) module 122) using speech recognition model(s). Cloud-based TTS module 116 may be configured to leverage the virtually limitless resources of the cloud to convert textual data (e.g., text formulated by automated assistant) into computer-generated speech output using speech synthesis model(s). In some implementations, the cloud-based TTS module 116 may provide the computer-generated speech output to one or more of the assistant devices 106 to be output directly, e.g., using respective speaker(s) 108 of the respective assistant devices. In other implementations, textual data (e.g., a client device notification included in a command) generated by the automated assistant using the cloud-based TTS module 116 may be provided to speech capture/TTS/STT module 114 of the respective assistant devices, which may then locally convert the textual data into computer-generated speech using the speech synthesis model(s), and cause the computer-generated speech to be rendered via local speaker(s) 108 of the respective assistant devices.

The NLP module 122 processes natural language input generated by users via the assistant input devices 106 and may generate annotated output for use by one or more other components of the automated assistant, the assistant input devices 106. For example, the NLP module 122 may process natural language free-form input that is generated by a user via one or more respective user interface input devices of the assistant input devices 106. The annotated output generated based on processing the natural language free-form input may include one or more annotations of the natural language input and optionally one or more (e.g., all) of the terms of the natural language input.

In some implementations, the NLP module 122 is configured to identify and annotate various types of grammatical information in natural language input. For example, the NLP module 122 may include a part of speech tagger configured to annotate terms with their grammatical roles. In some implementations, the NLP module 122 may additionally and/or alternatively include an entity tagger (not depicted) configured to annotate entity references in one or more segments such as references to people (including, for instance, literary characters, celebrities, public figures, etc.), organizations, locations (real and imaginary), and so forth. In some implementations, data about entities may be stored in one or more databases, such as in a knowledge graph (not depicted). In some implementations, the knowledge graph may include nodes that represent known entities (and in some cases, entity attributes), as well as edges that connect the nodes and represent relationships between the entities.

The entity tagger of the NLP module 122 may annotate references to an entity at a high level of granularity (e.g., to enable identification of all references to an entity class such as people) and/or a lower level of granularity (e.g., to enable identification of all references to a particular entity such as a particular person). The entity tagger may rely on content of the natural language input to resolve a particular entity and/or may optionally communicate with a knowledge graph or other entity database to resolve a particular entity.

In some implementations, the NLP module 122 may additionally and/or alternatively include a coreference resolver (not depicted) configured to group, or “cluster,” references to the same entity based on one or more contextual cues. For example, the coreference resolver may be utilized to resolve the term “it” to “front door lock” in the natural language input “lock it”, based on “front door lock” being mentioned in a client device notification rendered immediately prior to receiving the natural language input “lock it”.

In some implementations, one or more components of the NLP module 122 may rely on annotations from one or more other components of the NLP module 122. For example, in some implementations the named entity tagger may rely on annotations from the coreference resolver and/or dependency parser in annotating all mentions to a particular entity. Also, for example, in some implementations the coreference resolver may rely on annotations from the dependency parser in clustering references to the same entity. In some implementations, in processing a particular natural language input, one or more components of the NLP module 122 may use related data outside of the particular natural language input to determine one or more annotations—such as an assistant input device notification rendered immediately prior to receiving the natural language input on which the assistant input device notification is based.

Assistant input device 106 further includes an action identifier 120 that can determine that a user has performed one or more actions. In some implementations, action identifier 120 can monitor the user interface components 107 to determine when the interface has been updated. For example, action identifier 120 can determine that a graphical user interface has changed and, in response, capture an image of the interface. Thus, in some implementations, action identifier 120 can periodically capture screenshots of a graphical interface and provide the screenshots to one or more other components, such as image analysis engine 130, for further analysis and/or processing.

In some implementations, action identifier 120 can identify instances of the user interacting with one or more interfaces of assistant input device 106. For example, action identifier 120 can periodically determine whether the graphical interface of assistant input device 106 has been updated and, in instances whereby the interface has changed in some manner, capture one or more screenshots of the interface. Also, for example, an application can provide action identifier 120 with an indication that the user is interacting with the application and, in response, action identifier 120 can capture one or more screenshots and/or request one or more other components to provide additional information regarding the action(s) performed by the user.

In some implementations, action identified can receive user interface interactions from a component that has provided an interface overlay that is invisible to the user but can identify where a user has interacted with the graphical interface. For example, when a user is interacting with a graphical interface and has indicated that the actions of the user be identified, one or more components can execute an invisible overlay that covers the graphical interface. Thus, in addition to identifying the elements that are rendered to the interface, action identifier 120 can identify where, on a given interface, the user has selected and/or interacted. By doing so, the action identifier can determine which rendered element the user has selected.

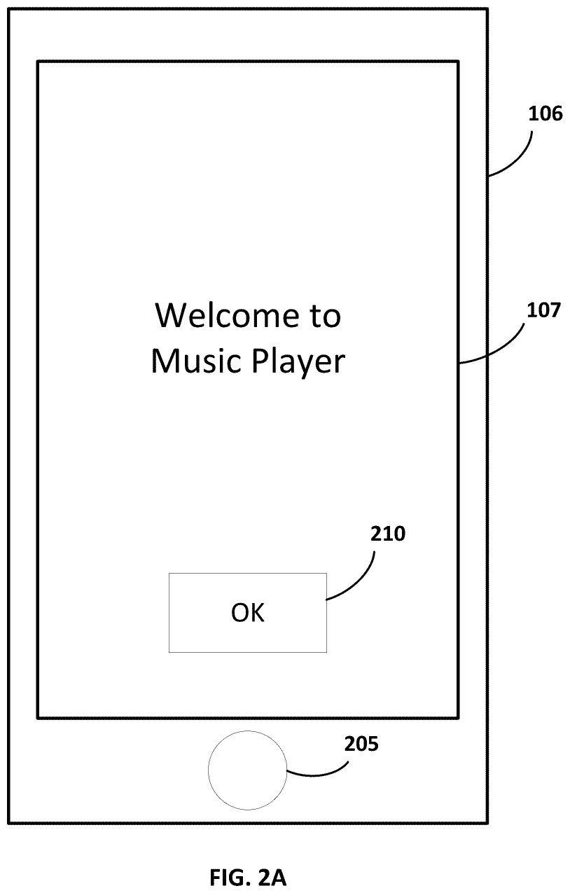

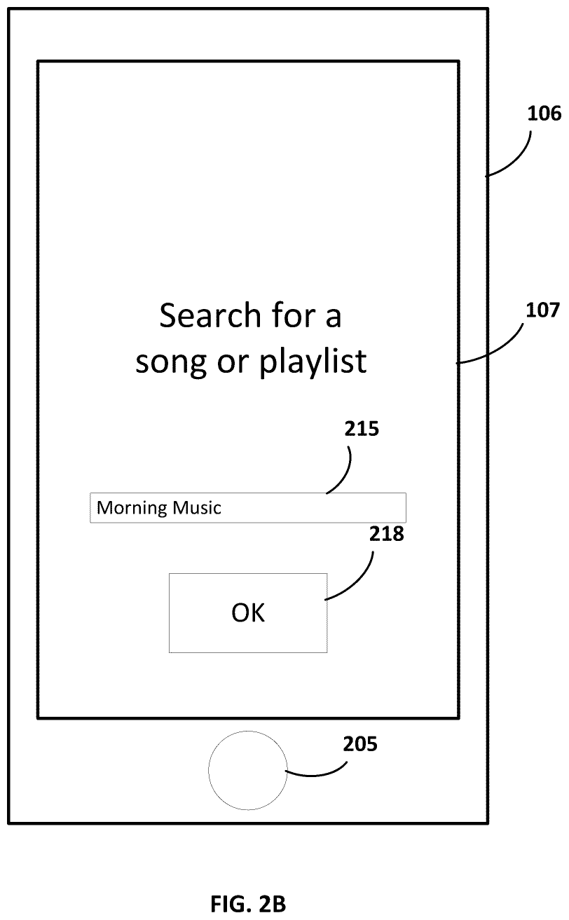

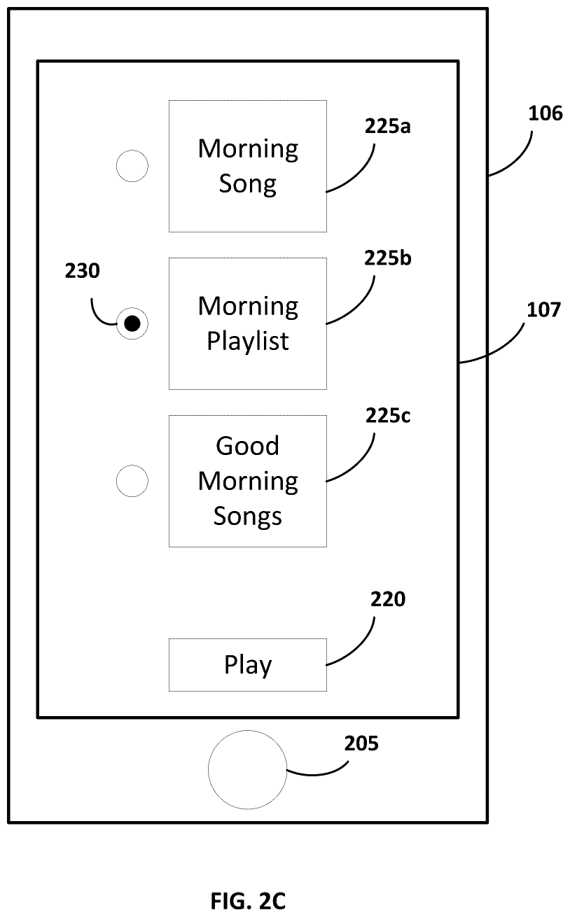

As an example, a user may be interacting with a media playback application that is executing on assistant input device 106. Referring to FIG. 2A, assistant input device 106 is illustrated with interface 107 displaying a graphical user interface of the media playback application. The interface 107 includes a button 210 that the user can interact with by touching the interface 107. The assistant input device 106 further includes a physical button 205 that the user can press to cause one or more actions to occur. For example, the user can select the physical button 205 to cause the interface 107 to display a home screen and/or to cause the assistant input device 106 to enter a standby mode.

When the user selects the button 210, the interface 107 updates to display an additional graphical interface of the media playback application. When the user selects the button 210, the application can provide action identifier 120 with an indication that the user has selected a location of the interface 107 and further indicate coordinates where the user selected the interface 107. Further, action identifier 120 can capture a screenshot of the interface 107. Based on identifying the location where the user selected the interface and a screenshot of the interface, one or more components, such as image analysis engine 130, can determine an action that was performed by the user, as further described herein.

The graphical user interface illustrated in FIG. 2B includes a text box 215 to allow a user to enter textual information that can be utilized to identify a song and/or playlist that the user has interest in having played via the application. As illustrated, the user has entered “Workout Music” which may be a name of a song and/or a playlist that is accessible via the application. Once the user has entered the text into text box 215, the user can select the button 218 to cause the application to process the text that was entered into text box 215.

For each of the actions that were performed by the user, action identifier 120 may capture one or more screenshots and/or a recording of screenshots in a sequential order (i.e., a screen recording that captures multiple frames of user interactions). For example, when the user enters textual information into the text box 215, action identifier 120 can capture one or more screenshots of the user activity. Also, for example, when the user selects the button 218, the application (or another application executing on mobile device 106) can provide the action identifier 120 with an indication that the user has selected a button and action identifier 120 can capture one or more screenshots, identify locations on the interface where the user has interacted, and/or determine, based on additional information from the application, that the user has performed an action.

Referring to FIG. 2C, another graphical interface is illustrated that can be rendered via interface 107 by a media playback application. The graphical interface illustrates three possible selections that may fulfill the user request (as provided by the user via the text box of the interface illustrated in FIG. 2B). As illustrated, the possible selections include “Morning Song” 225a, “Workout playlist” 225b, and “Good Morning Songs” 225c. Each of the selections is further provided with a radio button, of which button 230 is selected. The user can interact with the interface 107 to select which of the selections (225a, 225b, and/or 225c) the user has interest in being played via the application. Once the user selects the correct selection, the button 220 can be selected to indicate a selection has been made.

As with previous interfaces, action identifier 120 can capture screenshots of the interface 107. For example, when the user interacts with button 220, a screenshot of the interface can be captured by action identifier 120. Also, for example, screenshots can be captured by action identifier 120 on a periodic basis and further utilized by image analysis engine 130 to determine one or more actions performed by the user while the user was interacting with the application. Further, user interface interaction data (e.g., indications of the user selecting a location of the interface, coordinates of the interface where the user selected) can be provided to action identifier 120 with screenshots which can be utilized by image analysis engine 130 to determine one or more actions that were performed by the user.

Image analysis engine 130 can process one or more screenshots to determine one or more actions that were performed by the user while the screenshots were captured. For example, as previously described, action identifier 120 can capture one or more screenshots and provide the screenshots to image analysis engine 130 for further processing. In some implementations, additional information related to the actions of the user can be provided with the screenshots, such as user interface interaction data, API information from the application, hardware information related to the assistant input device 106, and/or other information related to the user interacting with an application that is executing on the assistant input device 106. In some implementations, the application with which the user is interacting can provide, in lieu of screenshots, one or more API calls that indicate what the user performed. For example, an API call of “Music_application (“Workout Playlist”, start)” can be provided to action identifier 120 directly.

In some implementations, image analysis engine 130 can process one or more provided screenshots by comparing a given screenshot with one or more screenshots that are associated with known actions of a user. For example, image analysis engine 130 may have access to a plurality of images, each of which has been tagged with a particular action that is illustrated by the screenshot (e.g., “select OK button,” “Enter <song title> in text box”). When image analysis engine 130 determines that an image matches an image that has been tagged with a particular action, image analysis engine 130 can determine that the action was performed by the user.

In some implementations, image analysis engine 130 can utilize one or more machine learning models 150 to determine actions that were performed by the user while the images were captured. For example, a trained machine learning model can receive, as input, one or more screenshots of an interface. Output from the machine learning model can be utilized to determine an action that was performed by the user while the screenshot(s) were captured. For example, the machine learning model 150 can provide, as output, one or more probabilities that a particular action (or plurality of actions) were performed. The probabilities can be utilized to determine the most likely action that was performed by the user (and/or that an action can be determined with a threshold certainty), and a series of actions that resulted in the user performing a routine can be determined.

In some implementations, image analysis engine 130 can utilize one or more machine learning models 150 that provide, as output, an embedding in a vector space that can be compared to one or more other embeddings that correspond to known actions. For example, one or more embeddings, generated based on processing one or more screenshots, can be tagged with a template routine. When a screenshot is processed using the machine learning model, the machine learning can provide, as output, an embedding that can be compared to the embeddings in a vector space and, based on proximity between the new embedding and other embeddings, one or more template routines can be selected. Also, for example, embeddings can be tagged with known actions that were performed while the screenshot was captured and an action can be associated with the new embedding based on proximity between the new embedding and one or more known action embeddings.

In some implementations, image analysis engine 130 can utilize one or more vision language models (VLM) to identify, based on interface screenshots, actions performed by a user while the user is interacting with an application. For example, a VLM can be provided, as input, one or more screenshots and a prompt to provide, as output, one or more actions that were performed by the user. Prompts can include, for example, “describe what action was performed by the user,” “provide, using nomenclature of <application>, the performed actions,” and/or one or more other prompts that can result in the VLM providing, as output, an action that was performed by the user while the user was interacting with the interface as illustrated in the provide screenshot(s) and/or while interacting with “<application>.” Also, for example, a VLM can be provided with a screenshot and a listing of possible actions and be prompted to “select which, if any, of these actions was performed by the user.”

Fulfillment engine 180 can determine an action to perform to fulfill a request of a user. For example, a user may utter a request of “OK Assistant, turn on the lights,” and the request can be processed as previously described. Subsequently, the request can be provided to fulfillment engine 180 to determine what actions to perform and/or what applications can be notified to perform the requested action. For example, the fulfillment engine 180 can transmit a notification to an application that controls smart lighting in a location and indicate that the “lights” should be set to an “on” status. Also, for example, a user may utter a phrase of “Open my music application” and fulfillment engine 180 can determine what application the user is referring to and further indicate to the operating system to open the intended application.

In some implementations, fulfillment engine 180 may determine that a request from a user cannot be fulfilled. For example, the automated assistant 118 may not be configured to interact with an application that is included in a request from the user, the request may include one or more terms that the automated assistant 118 cannot comprehend, and/or one or more other aspects of the request may prevent the automated assistant 118 from fulfilling the request via the fulfillment engine 180.

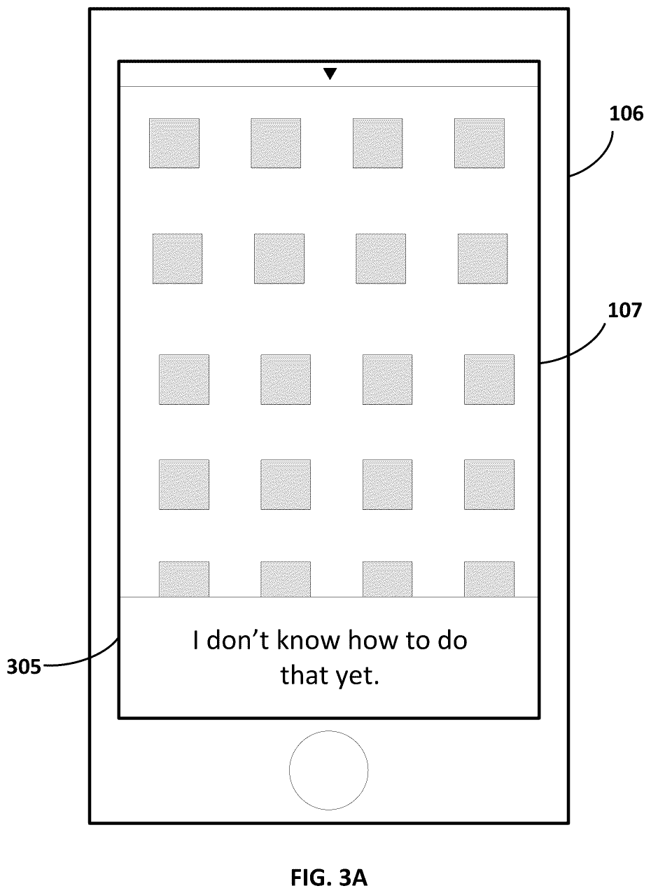

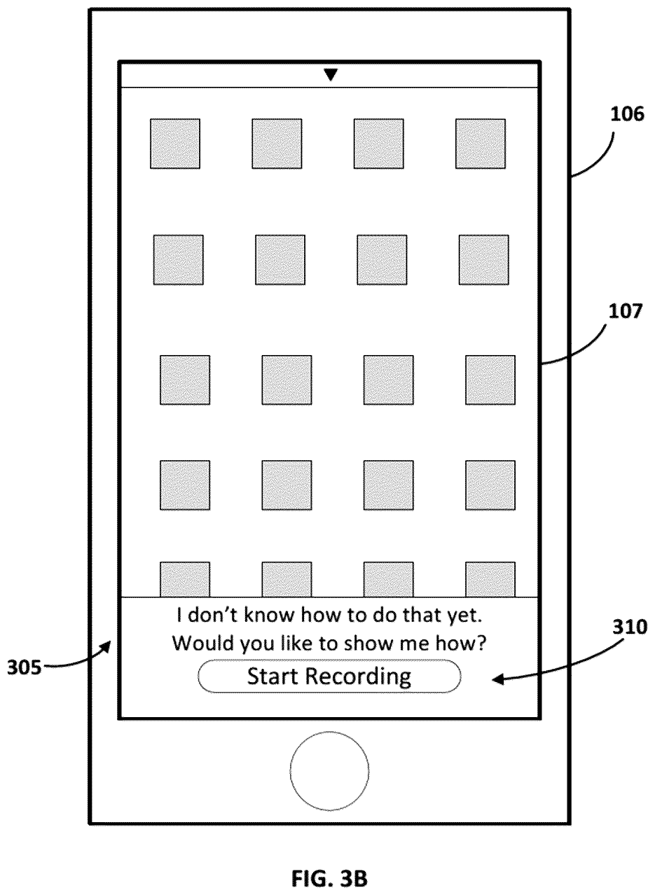

In response, the fulfillment engine 180 may provide a failure notification indicating that the automated assistant 118 is unable to fulfill the submitted request. For example, referring to FIG. 3A, the interface of assistant input device 106 is provided. The interface 107, as illustrated, can be generated in response to the user submitting a request, such as uttering “OK Assistant, play Book 1 on Application A.” The utterance can be processed as previously described (e.g., STT, ASR, NLU), and the request can be provided to the fulfillment engine 180. If the fulfillment engine 180 determines that the request cannot be fulfilled due to the automated assistant 118 not understanding the request and/or determining that the automated assistant 118 is not configured to fulfill the request, the fulfillment engine 180 can instead provide a failure notification 305 that indicates that the request cannot be fulfilled.

In some implementations, the fulfillment engine 180 can provide a notification that indicates that the request cannot be fulfilled, but that the automated assistant 118 can determine, via the actions of the user performing a routine, how to perform the requested routine. For example, automated assistant 118 can determine that it cannot fulfill “Play Book 1 on Application A,” but may be capable of performing the routine if the user demonstrates the actions that are included in the routine. Once the automated assistant 118 has determined the actions that are required to perform the routine, subsequent submissions of the request can be fulfilled and not require a failure notification to be provided to the user.

As an example, referring to FIG. 2B, an interface 107 is illustrated for assistant input device 106. The interface includes a failure notification 305 that indicates that the automated assistant 118 was unable to fulfill a submitted request (e.g., the user uttering “OK Assistant, play Book 1 on Application A”). The notification indicates that “I don't know how to do that yet. Would you like to show me how?” with a button 310 that, by selecting, allows the user to grant permissions to initiate identifying user actions by the automated assistant 118. For example, once the user selects button 310, previously described techniques (e.g., processing of screen captures and/or recordings, machine learning model and/or image analysis, invisible interface overlay, utilizing API calls between the operating system and an application) can be utilized to determine the actions of the user.

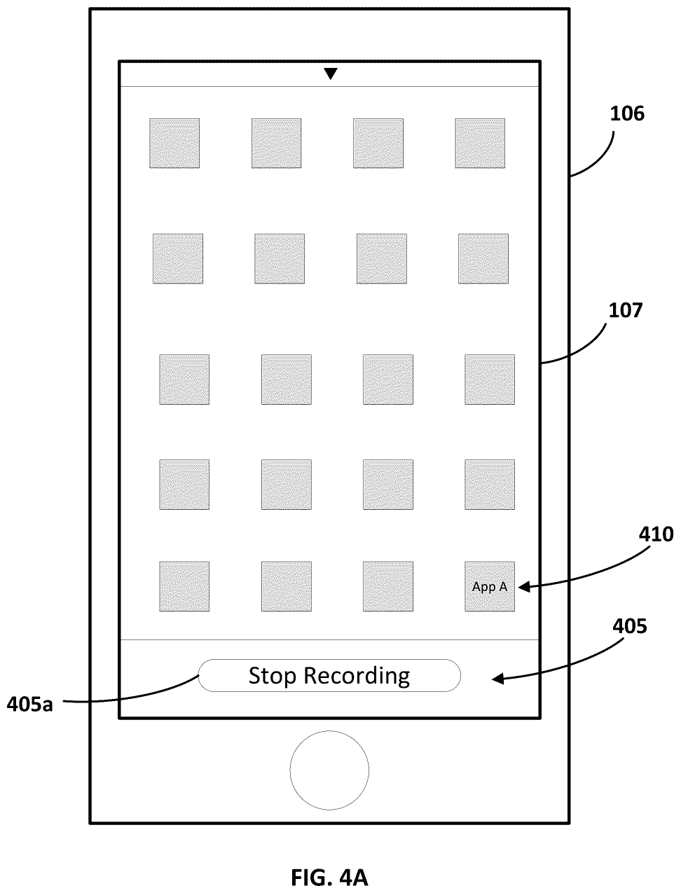

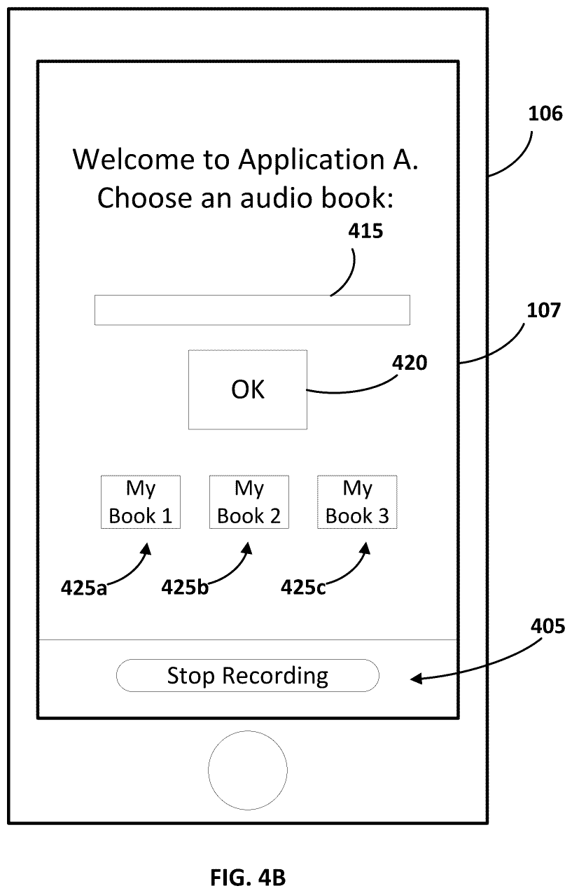

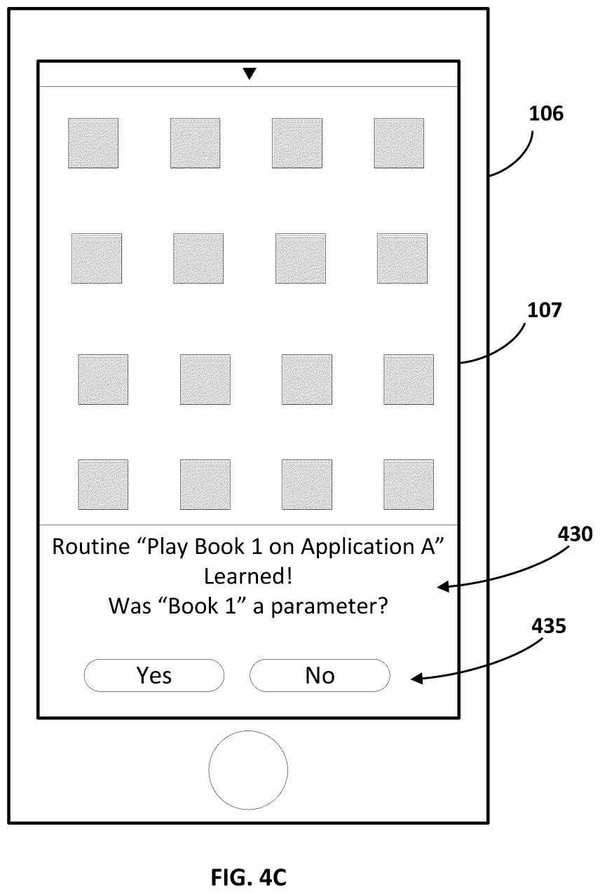

Referring to FIG. 4A, an interface 107 is illustrated that can be provided to the user when the user has selected to allow the automated assistant 118 to identify the actions of the user. For example, if the user has selected button 310 of FIG. 3B, the interface 107 can be updated to render a notification element 405 that indicates that the action identifier 120 is identifying the actions of the user. Once the user has completed a routine (i.e., a series of actions), the user can select the “Stop Recording” button 405a and the action identifier 120 can stop identifying user actions and determine that the identified user actions are part of a routine that has been completed. Depending on how the actions were identified, image analysis engine 130 can determine the actions that were performed based on information that was obtained while the automated assistant 118 was in a “record” mode. For example, one or more techniques previously described herein may be utilized to determine what actions were performed by the user between the time that the user selected “Start Recording” and selected “Stop Recording.”

As an example of recorded actions of the user, referring again to FIG. 4A, the interface 107 illustrates a plurality of application icons, including icon 410 for the application “Application A.” While the action identifier 120 is capturing screenshots and/or other capturing information that can be utilized to determine actions of the user, the user can select icon 410 to launch

“Application A.” Once the user has performed this action, referring to FIG. 4B, the application interface can be rendered to the user. In this instance, “Application A” is an audio book player, and the user is provided with a display that includes a text box 415 for textually providing a book name, an “OK” button 420 to confirm that the book entered into text box 415 is correct, and selection elements 425a-425c to allow a user to select a book that was previously selected for playback. Further, the interface 107 includes a notification 405 that allows the user to stop recording of actions when a routine has been completed.

When the user has been provided with the interface 107 of FIG. 4B, the user may provide a textual representation of the book to play via text box 415. For example, the user can enter “Book 1” into the text box 415 and select the “OK” button 420. Action identifier 120 can determine what was entered by the user and record the text and selection of the button 420 as one or more actions (after possibly being further processed by image analysis engine 130. Additionally or alternatively, the user can select one of the previously played books by selecting elements 425a-425c and action identifier 120 can determine which element was selected.

The user can select the “Stop Recording” button 405a when the routine has been completed. In response, the fulfillment engine 180 and/or one or more other components can provide a notification 430 that indicates that the request can now be completed by the automated assistant 118. For example, as illustrated in FIG. 4C, the notification 430 indicates that “Play Book 1 on Application A” has been learned by the automated assistant 118. Thus, subsequently, when the user utters and/or provides a request of “Play Book 1 on Application A,” the automated assistant 118 can determine that the request matches the previously taught routine that has a request of “Play Book 1 on Application A” and perform the same actions (or series of actions that accomplish the same result) that the user performed. Thus, the automated assistant 118 may no longer provide a failure notification to the user when the request “Play Book 1 on Application A” is provided by the user.

In some implementations, one or more terms of a request may be parameters that can vary between requests but otherwise similar actions can be performed to complete a routine. For example, a user may provide a request of “Play Book 1 on Application A” and the user may additionally provide a request of “Play Book 2 on Application A.” Besides a difference in the book being requested, the automated assistant 118 would likely perform the same other actions to complete either routine. Thus, in some implementations, the automated assistant and/or one or more other components can determine whether one or more terms of a request are parameters and, in response, generate a general routine that can be utilized to process multiple requests from the user.

Parameter identification engine 140 can determine whether one or more terms in a request are parameters that can vary from request to request while otherwise including the same actions. For example, in some implementations, parameter identification engine 140 can identify that one or more terms in a request correspond to an action that was performed by the user that included the user selecting an element that was associated with the parameter. By determining that one or more of the terms is associated with an action that was performed by the user, parameter identification engine 140 can provide a notification to the user that inquires as to whether a particular term is a parameter.

For example, referring again to FIG. 4, notification 430 includes the phrase “Was ‘Book 1’ a parameter?,” which can be included with the notification indicating success of learning the routine. In this instance, for example, parameter identification engine 140 may have identified that the request included the term(s) “Book 1” and that the user entered “Book 1” into the text box 415 or selected an icon 425a that indicated “Book 1.” Thus, by identifying that one of the actions of the user included providing “Book 1” as input (or as a selection from a group of possible values), parameter identification engine 140 can determine that “Book 1” can be replaced by other values that are of the same parameter type as “Book 1,” such as “Book 2” and “Book 3.”

In some implementations, parameter identification engine 140 can determine, based on past interactions of the user and/or other users, whether one or more terms of a request (and/or one or more actions of a routine) are parameterizable such that the user can specify different values to cause a similar routine to be performed. Referring again to FIG. 1, past user interaction identifier 160 can determine, for a request, whether one or more other similar requests were submitted by a user (either the current user or another user). For example, the user may submit a request of “Play Book 1 on Application A,” action identifier 120 can determine the actions that are included in the routine, and past user interaction identifier 160 can identify other requests from users that are similar to “Play Book 1 on Application A.” Similar requests can include, for example, a request of “Play Book 1 on Application B” and a request of “Play Book 2 on Application A.” In some implementations, past user interaction identifier 160 may identify routines that were previously taught to the automated assistant and determine that the actions of one or more previously taught routines are similar to the currently taught routine. For example, a routine for “Play Book 1 on Application A” can include selecting an “Application A” application icon, entering “Book 1” into a text box, and selecting an “OK” button, as previously described with regards to FIGS. 4A to 4C. Similarly, past user interaction identifier 160 may identify a past user interaction for the routine “Play Book 2 on Application A” that includes the user selecting the “Application A” icon, entering “Book 2” into a text box, and selecting “OK.” Further, past user interaction identifier 160 may identify a previous routine of “Play Book 1 on Application B,” but because a different application was being utilized, one or more of the actions may not be similar to “Play Book 1 on Application A” such that the past interactions of the user with “Application B” may not be utilized to determine whether one or more terms are parameterizable.

Once past interactions are identified, parameter identification engine 140 can utilize one or more pattern matching and/or semantic matching techniques to determine a general routine that can be utilized to perform both the current routine and one or more previous routines that differ only by a parameter value. For example, a current routine of “Play Book 1 on Application A” may be determined based on the identified actions of the user, as previously described, and further, a previous routine of “Play Book 2 on Application A” can be identified by past user interaction identifier 160. In response, parameter identification engine 140 can determine a general request of “Play <book> on Application A” and further determine that the actions to perform the routine include selecting an “Application A” icon, providing <book> as input to the application, and selecting an “OK” button. Also, for example, parameter identification engine 140 can determine that one or more API calls may be made to “Application A,” with “<book>” as a parameter. Thus, the routine has been generalized such that any book may be requested by the user to be played via “Application A.”

In some implementations, once a general routine has been determined, one or more additional automated assistants may be provided with the routine to prevent one or more subsequent requests from resulting in a failure notification. For example, in some implementations, one or more automated assistants executing on other devices of the user may be provided with the general routine so that the user can provide the same request (or similar requests) via other devices and the other automated assistant(s) can determine a response based on the general routine. For example, a user may have initially utilized a smartphone to perform actions that were identified by the automated assistant and utilized to generate a general routine of “Play <book> on Application A.” The general routine can be shared with an automated assistant that is executing on a smart speaker so that, subsequently, if the user requests to “Play Book 4 on Application A” via the smart speaker, the automated assistant can fulfill the request.

In some implementations, a generated general routine can be provided to one or more automated assistants of other users. For example, as previously described, one or more components of an automated assistant may be executing in the cloud and the general routine can be stored in a database that is accessible to the cloud-based components. Thus, when a user (other than the user that performed the actions that generated the routine) submits a request that matches a pattern for the general routine (e.g., submitting “Play Book 5 on Application A” for a pattern of “Play <book> on Application A”), the request can be fulfilled by the automated assistant executing on a device of the other user.

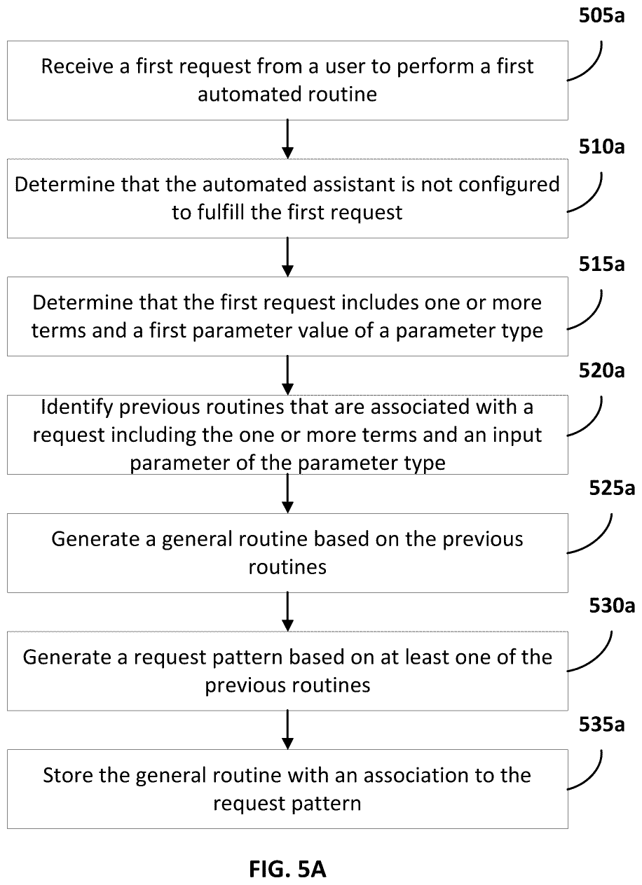

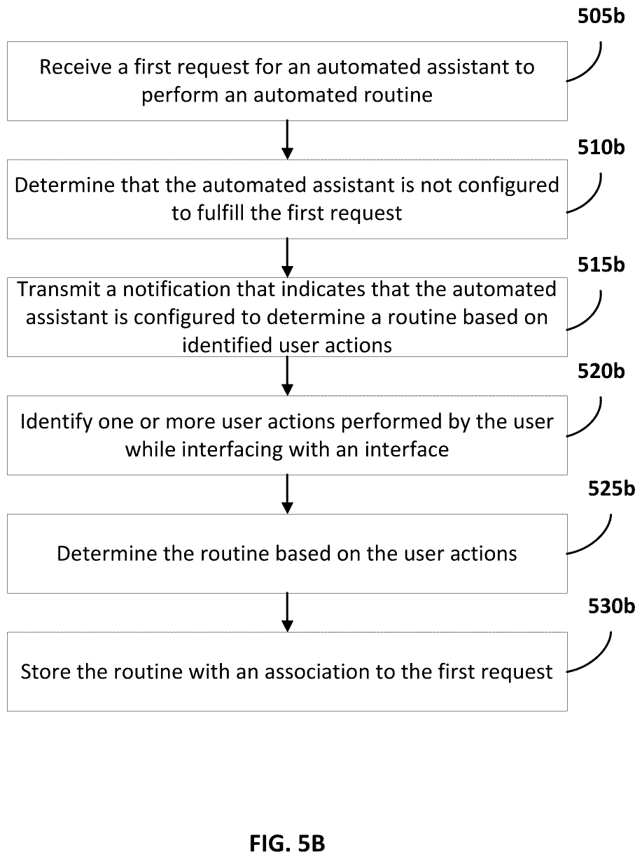

FIG. 5A depicts a flowchart illustrating an example method of generating a general routine based on identified user actions while performing a routine. For convenience, the operations of the method are described with reference to a system that performs the operations, such as the system illustrated in FIG. 1. This system of the method includes one or more processors and/or other component(s) of a client device. Moreover, while operations of the method are shown in a particular order, this is not meant to be limiting. One or more operations may be reordered, omitted, or added.

At step 505a, a first request from a user to perform a first automated routine is received. The request may be spoken by the user (e.g., an utterance directed to the automated assistant) and/or the request can be textually provided by the user. In instances where the request is an utterance, the audio data capturing the request can be processed utilizing ASR, STT, NLU, and/or other processes to generate a representation of the request that can be utilized by a fulfillment engine, such as fulfillment engine 180.

At step 510a, a determination is made that the automated assistant is not configured to fulfill the first request of the user. For example, the first request can be processed, as previously described, and provided to fulfillment engine 180. Fulfillment engine 180 can determine that the request cannot be fulfilled because the request is unknown, and can provide a notification that can be provided to the user indicating that the request is unknown to the automated assistant. Thus, in instances where the fulfillment engine 180 can fulfill a request, the request is fulfilled. However, in instances where the fulfillment engine 180 does not know the request, the notification can be provided to the user. In some implementations, the notification can be provided with an option for the user to perform one or more actions to demonstrate to the automated assistant how to fulfill the request (i.e., perform the actions of the routine that was requested by the user).

At step 515a, a determination is made that the first request includes one or more terms and a first parameter value of a parameter type. In some implementations, the parameter in the first request can be determined based on one or more of the actions of the user while demonstrating the routine includes the value of the parameter. For example, a user may request to “Play Book 1 on Application A.” When performing the actions to demonstrate how to fulfill the request, the user may provide “Book 1” as input. In response, parameter identification engine 140 can determine that “Book 1” is a value for a parameter and further that the parameter has a type of “book” based on, for example, identifying an association between “book” and “Book 1” in a knowledge graph. For the previous example, parameter identification engine 140 can identify “Play” and “on Application A” as one or more terms and “Book 1” as an input parameter value of parameter type “book.”

At step 520a, one or more previous routines that are each associated with a corresponding request are identified based on the corresponding requests including the one or more terms and a parameter value of the parameter type. For example, as previously described, the user may select an option to demonstrate how to perform the routine. In this instance, the previous routine includes the actions performed by the user and the first request. Also, for example, previously performed routines that were performed by the user and/or other users to demonstrate to the automated assistant how to perform the routine, can be included in the previous routines. For example, another user may have provided a request of “Play Book 6 on Application A” to an automated assistant and, when the automated assistant determines that the request cannot be fulfilled, may have demonstrated the actions to perform the routine. Thus, one of the previous routines can be the set of actions and the corresponding request of “Play Book 6 on Application A.”

At step 525a, a general routine is generated based on one or more of the previous routines. The general routine can be based on the actions that were performed by the user (e.g., in response to the request of the user failing) and/or actions that were performed by one or more other users. The general routine can be executed with a value for a parameter that is included in requests. For example, for the request pattern “Play <book> on Application A,” the automated assistant may generate a general routine that includes the actions of “open Application A,” “enter <book>,” and “click OK.” At step 530a, the request pattern is generated. Further, at step 535a, the general routine is stored with an association to the request pattern.

FIG. 5B depicts a flowchart illustrating another example method of generating a routine based on identified user actions while performing a routine. For convenience, the operations of the method are described with reference to a system that performs the operations, such as the system illustrated in FIG. 1. This system of the method includes one or more processors and/or other component(s) of a client device. Moreover, while operations of the method are shown in a particular order, this is not meant to be limiting. One or more operations may be reordered, omitted, or added.

At step 505b, a first request from a user to perform a first automated routine is received. The request may be spoken by the user (e.g., an utterance directed to the automated assistant) and/or the request can be textually provided by the user. In instances where the request is an utterance, the audio data capturing the request can be processed utilizing ASR, STT, NLU, and/or other processes to generate a representation of the request that can be utilized by a fulfillment engine, such as fulfillment engine 180.

At step 510b, a determination is made that the automated assistant is not configured to fulfill the first request of the user. For example, the first request can be processed, as previously described, and provided to fulfillment engine 180. Fulfillment engine 180 can determine that the request cannot be fulfilled because the request is unknown, and can provide a notification that can be provided to the user indicating that the request is unknown to the automated assistant. Thus, in instances where the fulfillment engine 180 can fulfill a request, the request is fulfilled. However, in instances where the fulfillment engine 180 does not know the request, the notification can be provided to the user. In some implementations, the notification can be provided with an option for the user to perform one or more actions to demonstrate to the automated assistant how to fulfill the request (i.e., perform the actions of the routine that was requested by the user).

At step 515b, a notification is provided to the user indicating that the automated assistant is not configured to perform the requested routine and further that, if the user performs the actions that are included in the routine, the automated assistant can be configured to perform the routine when the user subsequently requests the routine. The notification can share one or more characteristics with the notification 305 of FIG. 3B

At step 520b, one or more actions that are performed by the user while interacting with the interface are identified. For each of the actions that were performed by the user, action identifier 120 may capture one or more screenshots and/or a recording of screenshots in a sequential order (i.e., a screen recording that captures multiple frames of user interactions). For example, when the user enters textual information into the text box 215, action identifier 120 can capture one or more screenshots of the user activity. Also, for example, when the user selects the button 218, the application (or another application executing on mobile device 106) can provide the action identifier 120 with an indication that the user has selected a button and action identifier 120 can capture one or more screenshots, identify locations on the interface where the user has interacted, and/or determine, based on additional information from the application, that the user has performed an action.

At step 525b, a routine is determined based on the user actions. The routine can include one or more of the actions that were performed by the user. In some implementations, the routine may include one or more actions that can be performed with alternative values, as previously described at step 525a. At step 530b, the routine is stored with an association to the first request. Thus, in future interactions, if the user requests the same routine, the automated assistant can perform the routine and not provide a failure notification.

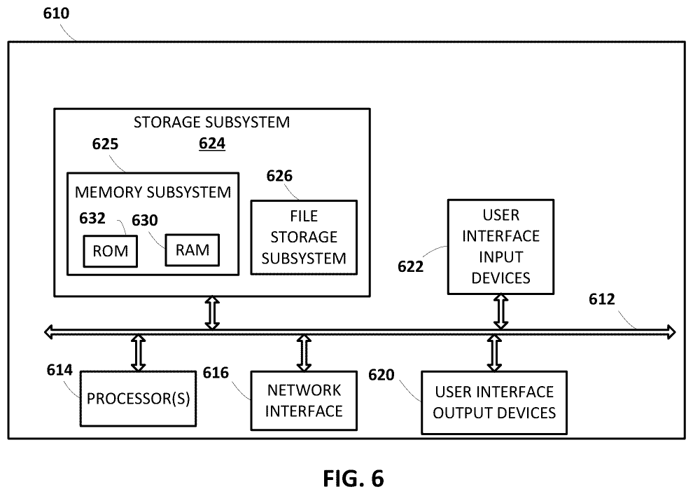

FIG. 6 is a block diagram of an example computing device 610 that may optionally be utilized to perform one or more aspects of techniques described herein. Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the method of FIG. 3, and/or to implement various components depicted in FIG. 1.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In some implementations, a method implemented by one or more processors is provided and includes receiving a first request from a user for an automated assistant to perform a first automated routine, and determining that the automated assistant is not configured to fulfill the first request. In response to determining that the automated assistant is not configured to fulfill the first request, the method further includes determining that the first request includes one or more terms and a first parameter value of a parameter type, identifying one or more previous routines, wherein each of the identified previous routines includes a plurality of user actions performed by the user and/or other users while interacting with an interface of a mobile device, and wherein the previous routines are each associated with a corresponding user input request that includes an input parameter of the parameter type and one or more of the terms generating a general routine based on the one or more previous routines, wherein executing the general routine with the first parameter value results in the automated assistant performing the first automated routine generating a request pattern based on a corresponding user input request of at least one of the previous routines, wherein the request pattern includes one or more of the terms and the parameter type; and storing the general routine with an association to the request pattern.

These and other implementations of the technology disclosed herein can include one or more of the following features.

In some implementations, the method further includes receiving a second request from the user for the automated assistant to perform a second automated routine, wherein the second request includes one or more of the terms and a second parameter value of the parameter type and determining that the second request matches the request pattern. In response to determining that the second request matches the request parameter, the method includes causing the general routine to be executed with the second parameter value.

In some implementations, the method further includes, in response to determining that the automated assistant is not configured to fulfill the first request, transmitting a notification, wherein the notification indicates that the automated assistant is not configured to fulfill the first request and is configured to determine, based on user interactions with an interface of the mobile device, a routine to fulfill the first request and identifying one or more user actions performed by the user, wherein the one or more user actions correspond to one or more of the interactions of the user with the interface, wherein determining the general routine is further based on the one or more user actions. In some of those implementations, identifying the one or more user actions includes receiving a plurality of screenshots of an interface captured while the user is interacting with the interface and processing the screenshots to identify the one or more user actions. In some of those instances, processing the screenshots includes providing the screenshots as input to a trained machine learning model, receiving, as output, one or more indications of an action that was performed by the user while the screenshots were captured, and processing the indications to determine the one or more user actions. In other of those implementations, generating the request pattern includes identifying a parameter value included in the request, determining that at least one of the user actions includes the parameter value, and selecting the parameter type of the parameter value to include in the request pattern.

In some implementations, the method further includes providing the general routine to one or more additional automated assistants.

In other implementations, a method implemented by one or more processors is provided and includes receiving a first request from a user for an automated assistant, executing at least in part on a mobile device, to perform an automated routine and determining that the automated assistant is not configured to fulfill the first request. In response to determining that the automated assistant is not configured to fulfill the first request, the method further includes transmitting a notification, wherein the notification indicates that the automated assistant is not configured to fulfill the first request and is configured to determine, based on user interactions with an interface of the mobile device, a routine to fulfill the first request, identifying one or more user actions performed by the user, wherein the one or more user actions correspond to one or more interactions of the user with the interface, determining the routine based on the one or more user actions, and storing the routine with an association to the first request.

These and other implementations of the technology disclosed herein can include one or more of the following features.

In some implementations, the method further includes generating a request pattern, wherein the request pattern includes one or more terms of the first request and a parameter type of one or more other terms of the first request and associating the request pattern with the routine, wherein the routine includes at least one action that is performed utilizing a value of the parameter type.

In some implementations, the request pattern is further generated based on previous interactions of the user.

In some implementations, the method further includes receiving a second request from the user to perform a requested routine, determining that the second request matches the request pattern, identifying a request parameter value from one or more terms of the second request, and causing the routine to be executed with the request parameter value.

In some implementations, the method further includes receiving a second request from the user for the automated assistant to perform the automated routine and causing the routine to be executed.

In some implementations identifying the one or more user actions includes receiving a plurality of screenshots of an interface captured while the user is interacting with the interface and processing the screenshots to identify the one or more user actions.

In some implementations, generating the request pattern includes identifying a parameter value included in the request, determining that at least one of the user actions includes the parameter value, and selecting the parameter type of the parameter value to include in the request pattern.

Other implementations may include a non-transitory computer readable storage medium storing instructions executable by one or more processors (e.g., central processing unit(s) (CPU(s)), graphics processing unit(s) (GPU(s)), and/or tensor processing unit(s) (TPU(s)) to perform a method such as one or more of the methods described above and/or elsewhere herein. Yet other implementations may include a system of one or more computers that include one or more processors operable to execute stored instructions to perform a method such as one or more of the methods described above and/or elsewhere herein.

In situations in which certain implementations discussed herein may collect or use personal information about users (e.g., user data extracted from other electronic communications, information about a user's social network, a user's location, a user's time, a user's biometric information, and a user's activities and demographic information, relationships between users, etc.), users are provided with one or more opportunities to control whether information is collected, whether the personal information is stored, whether the personal information is used, and how the information is collected about the user, stored and used. That is, the systems and methods discussed herein collect, store and/or use user personal information only upon receiving explicit authorization from the relevant users to do so.

For example, a user is provided with control over whether programs or features collect user information about that particular user or other users relevant to the program or feature. Each user for which personal information is to be collected is presented with one or more options to allow control over the information collection relevant to that user, to provide permission or authorization as to whether the information is collected and as to which portions of the information are to be collected. For example, users can be provided with one or more such control options over a communication network. In addition, certain data may be treated in one or more ways before it is stored or used so that personally identifiable information is removed. As one example, a user's identity may be treated so that no personally identifiable information can be determined. As another example, a user's geographic location may be generalized to a larger region so that the user's particular location cannot be determined.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A method implemented by one or more processors, the method comprising:
receiving a first request from a user for an automated assistant to perform a first automated routine;
determining that the automated assistant is not configured to fulfill the first request;
in response to determining that the automated assistant is not configured to fulfill the first request:
determining that the first request includes one or more terms and a first parameter value of a parameter type;
identifying one or more previous routines, wherein each of the identified previous routines includes a plurality of user actions performed by the user and/or other users while interacting with an interface of a mobile device, and wherein the previous routines are each associated with a corresponding user input request that includes an input parameter of the parameter type and one or more of the terms;
generating a general routine based on the one or more previous routines, wherein executing the general routine with the first parameter value results in the automated assistant performing the first automated routine;
generating a request pattern based on a corresponding user input request of at least one of the previous routines, wherein the request pattern includes one or more of the terms and the parameter type; and
storing the general routine with an association to the request pattern.

2. The method of claim 1, further comprising:
receiving a second request from the user for the automated assistant to perform a second automated routine, wherein the second request includes one or more of the terms and a second parameter value of the parameter type;
determining that the second request matches the request pattern; and
in response to determining that the second request matches the request parameter:
causing the general routine to be executed with the second parameter value.

3. The method of claim 1, further comprising:
in response to determining that the automated assistant is not configured to fulfill the first request:
transmitting a notification, wherein the notification indicates that the automated assistant is not configured to fulfill the first request and is configured to determine, based on user interactions with an interface of the mobile device, a routine to fulfill the first request; and
identifying one or more user actions performed by the user, wherein the one or more user actions correspond to one or more of the interactions of the user with the interface, wherein determining the general routine is further based on the one or more user actions.

4. The method of claim 3, wherein identifying the one or more user actions includes:
receiving a plurality of screenshots of an interface captured while the user is interacting with the interface; and
processing the screenshots to identify the one or more user actions.

5. The method of claim 4, wherein processing the screenshots includes:
providing the screenshots as input to a trained machine learning model;
receiving, as output, one or more indications of an action that was performed by the user while the screenshots were captured; and
processing the indications to determine the one or more user actions.

6. The method of claim 3, wherein generating the request pattern includes:
identifying a parameter value included in the request;
determining that at least one of the user actions includes the parameter value; and
selecting the parameter type of the parameter value to include in the request pattern.

7. The method of claim 1, further comprising:
providing the general routine to one or more additional automated assistants.

8. A method implemented by one or more processors, the method comprising:
receiving a first request from a user for an automated assistant, executing at least in part on a mobile device, to perform an automated routine;
determining that the automated assistant is not configured to fulfill the first request;
in response to determining that the automated assistant is not configured to fulfill the first request:
transmitting a notification, wherein the notification indicates that the automated assistant is not configured to fulfill the first request and is configured to determine, based on user interactions with an interface of the mobile device, a routine to fulfill the first request;
identifying one or more user actions performed by the user, wherein the one or more user actions correspond to one or more interactions of the user with the interface;
determining the routine based on the one or more user actions; and
storing the routine with an association to the first request.

9. The method of claim 8, further comprising:
generating a request pattern, wherein the request pattern includes one or more terms of the first request and a parameter type of one or more other terms of the first request; and
associating the request pattern with the routine, wherein the routine includes at least one action that is performed utilizing a value of the parameter type.

10. The method of claim 9, wherein the request pattern is further generated based on previous interactions of the user.

11. The method of claim 9, further comprising:
receiving a second request from the user to perform a requested routine;
determining that the second request matches the request pattern;
identifying a request parameter value from one or more terms of the second request; and
causing the routine to be executed with the request parameter value.

12. The method of claim 8, further comprising:
receiving a second request from the user for the automated assistant to perform the automated routine; and
causing the routine to be executed.

13. The method of claim 8, wherein identifying the one or more user actions includes:
receiving a plurality of screenshots of an interface captured while the user is interacting with the interface; and
processing the screenshots to identify the one or more user actions.

14. The method of claim 9, wherein generating the request pattern includes:
identifying a parameter value included in the request;
determining that at least one of the user actions includes the parameter value; and
selecting the parameter type of the parameter value to include in the request pattern.

15. A system, comprising:
one or more computers each including at least one processor and a memory storing processor-executable code, the one or more computers configured to:
receive a first request from a user for an automated assistant to perform a first automated routine;
determine that the automated assistant is not configured to fulfill the first request;
in response to determining that the automated assistant is not configured to fulfill the first request:
determine that the first request includes one or more terms and a first parameter value of a parameter type;
identify one or more previous routines, wherein each of the identified previous routines includes a plurality of user actions performed by the user while interacting with an interface of a mobile device, and wherein the previous routines are each associated with a corresponding user input request that includes an input parameter of the parameter type and one or more of the terms;
generate a general routine based on the one or more previous routines, wherein executing the general routine with the first parameter value results in the automated assistant performing the first automated routine;
generate a request pattern based on at least one of the previous routines, wherein the request pattern includes one or more of the terms and the parameter type; and
store the general routine with an association to the request pattern.

16. The system of claim 15, wherein one or more of the computers are further configured to:
receive a second request from the user for the automated assistant to perform a second automated routine, wherein the second request includes one or more of the terms and a second parameter value of the parameter type;
determine that the second request matches the request pattern; and
in response to determining that the second request matches the request parameter:
cause the general routine to be executed with the second parameter value.

17. The system of claim 15, wherein one or more of the computers are further configured to:
in response to determining that the automated assistant is not configured to fulfill the first request:
transmit a notification, wherein the notification indicates that the automated assistant is not configured to fulfill the first request and is configured to determine, based on user interactions with an interface of the mobile device, a routine to fulfill the first request; and
identify one or more user actions performed by the user, wherein the one or more user actions correspond to one or more of the interactions of the user with the interface, wherein determining the general routine is further based on the one or more user actions.

18. The system of claim 17, wherein one or more of the computers are further configured to, when identifying the one or more user actions:
receive a plurality of screenshots of an interface captured while the user is interacting with the interface; and
process the screenshots to identify the one or more user actions.

19. The system of claim 18, wherein one or more of the computers are further configured to, when processing the screenshots:
provide the screenshots as input to a trained machine learning model;
receive, as output, one or more indications of an action that was performed by the user while the screenshots were captured; and
process the indications to determine the one or more user actions.

20. The system of claim 17, wherein one or more of the computers are further configured to, when generating the request pattern:
identify a parameter value included in the request;
determine that at least one of the user actions includes the parameter value; and
select the parameter type of the parameter value to include in the request pattern.
